(19) United States
(12) Patent Application Publication
(10) Pub. No.: US 2004/0243559 A1
(43) Pub. Date: Dec. 2, 2004

(54) Client-side search engines

(76) Inventor: Mark Andrew Brundege, Denver, CO (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/449,358

(22) Filed: May 30, 2003

(51) Int. Cl. G06F 7/00

(52) U.S. Cl. 707/3

(57) ABSTRACT

Disclosed are novel methods and apparatus for provision of efficient, effective, and/or flexible client-side search engines. In accordance with an embodiment of the present invention, a client-side search engine is disclosed. The search engine includes: a delivery engine; content data accessible by the delivery engine; a data storage to store organizational data corresponding to the content data; a browser coupled to the delivery engine to communicate with the delivery engine; and a search engine coupled between the browser and the delivery engine to perform a search in accordance with one or more search terms provided by the browser.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to the software and data as described below and in the drawings hereto: Copyright© 2002, Sun Microsystems, Inc., All Rights Reserved.

### FIELD OF INVENTION

The present invention generally relates to the field of data handling. More specifically, an embodiment of the present invention provides for a client-side search engine.

### BACKGROUND OF INVENTION

As the number of computers increases worldwide, so does their use in educational settings. Many classrooms and libraries now provide access to data that may be located halfway around the world. Instead of a student having to be physically present in a classroom, the student may now attend a class by utilizing a computer thousands of miles away. In addition, training materials can be stored on computers (i.e., digitized) for use at a later time or while mobile.

Computer-based training materials are, however, largely developed on a proprietary (e.g., company-by-company) basis, resulting in high development costs and limited resale value. American companies alone spend billions of dollars a year on the development of training products with little of the investment focused on resale or external product development. To obviate these problem, the advanced distributive learning (ADL) initiative has been developing guidelines to create new markets for training materials, reduce the costs of development, and increase the potential return on investment. Further information regarding ADL may be found by reference to www.adlnet.org.

One common way to share educational information is to utilize a learning management system (LMS). An LMS generally includes solutions for cataloging, course registration, provision of a course, tracking (for example, by managers), and accounting. Such an LMS is typically a large software system, which can easily cost over $100,000. In most cases, an LMS is too costly for one user or cannot be run locally on a client's system, which may lack the necessary local resources. Moreover, network access to an LMS often requires a relatively fast network connection capable of shuttling the comprehensive amount of data involved. As such, a remote user (e.g., with only a 56 kbps modem) will have a hard time accessing an LMS.

One solution for sharing courseware amongst LMS providers is to use the sharable content object reference model (SCORM), which is developed by the ADL. SCORM provides a reference model that defines a Web-based learning content model. Moreover, SCORM provides a set of interrelated technical specifications designed to meet the Department of Defense's high-level requirements. SCORM is generally a desirable tool because it makes future changes more readily available. In other words, the content may be reusable in the future without having to rework significant amounts of data through different procedures. SCORM, however, generally only provides a table of contents or a set of menus to find titles of interest. This is in part because SCORM organizes its contents in such a way that it ends up getting rendered as a table of content or menu.

One problem with today's solutions is that a remote user (or one that has no network access) cannot perform searches on the course content readily. The online versions of courseware though generally have access to a server-based search engine. This problem generally exists even when the courseware is to be provided locally (e.g., through the same use's local compact disc-read only memories (CD-ROM)). Accordingly, the lack of user access to a server-based search engine currently hinders at least development and use of courseware.

### SUMMARY OF INVENTION

The present invention, which may be implemented utilizing a general-purpose digital computer, in certain embodiments of the present invention, includes novel methods and apparatus to provide efficient, effective, and/or flexible client-side search engines. In accordance with an embodiment of the present invention, a client-side search engine is disclosed. The search engine includes: a delivery engine; content data accessible by the delivery engine; a data storage to store organizational data corresponding to the content data; a browser coupled to the delivery engine to communicate with the delivery engine; and a search engine coupled between the browser and the delivery engine to perform a search in accordance with one or more search terms provided by the browser.

In another embodiment of the present invention, the search engine further includes a search index. The search index may store searchable data corresponding to the content data.

In a further embodiment of the present invention, the search index includes data selected from a group comprising text data, HTML comment data, metadata, image tag data, and image description data.

In a different embodiment of the present invention, the matching content is one or more SCOs, for example, in accordance with the SCORM standard.

### BRIEF DESCRIPTION OF DRAWINGS

The present invention may be better understood and its numerous objects, features, and advantages made apparent to those skilled in the art by reference to the accompanying drawings in which:

FIG. 1 illustrates an exemplary computer system 100 in which certain embodiments of the present invention may be implemented;

FIG. 2 illustrates an exemplary block diagram of a client-side system 200 in accordance with an embodiment of the present invention;

FIG. 3 illustrates an exemplary block diagram of a client-side system 300 with a search engine in accordance with an embodiment of the present invention;

FIG. 4 illustrates an exemplary client-side search engine system 400 in accordance with an embodiment of the present invention;

FIG. 5 illustrates an exemplary search parameter graphical user interface (GUI) 500 in accordance with an embodiment of the present invention;

FIG. 6 illustrates an exemplary search result display 600 in accordance with an embodiment of the present invention; and

FIG. 7 illustrates an exemplary full diagram of an index creation method 700 in accordance with an embodiment of the present invention.

The use of the same reference symbols in different drawings indicates similar or identical items.

### DETAILED DESCRIPTION

In the following description, numerous details are set forth. It will be apparent, however, to one skilled in the art that embodiments of the present invention may be practiced without these specific details. In other instances, well-known structures, devices, and techniques have not been shown in detail, in order to avoid obscuring the understanding of the description. The description is thus to be regarded as illustrative instead of limiting.

Reference in the specification to “one embodiment ”or “an embodiment ” means that a particular feature, structure, or characteristic described in connection with the embodiment is included in at least an embodiment of the invention. The appearances of the phrase “in one embodiment” in various places in the specification are not necessarily all referring to the same embodiment.

Also, select embodiments of the present invention include various operations, which are described herein. The operations of the embodiments of the present invention may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, embodiments of the present invention may be provided as computer program products, which may include machine-readable medium having stored thereon instructions used to program a computer (or other electronic devices) to perform a process according to embodiments of the present invention. The machine-readable medium may include, but is not limited to, floppy diskettes, hard disk, optical disks, CD-ROMs, and magneto-optical disks, read-only memories (ROMs), random-access memories (RAMs), erasable programmable ROMs (EPROMs), electrically EPROMs (EEPROMs), magnetic or optical cards, flash memory, or other types of media or machine-readable medium suitable for storing electronic instructions and/or data.

Additionally, embodiments of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

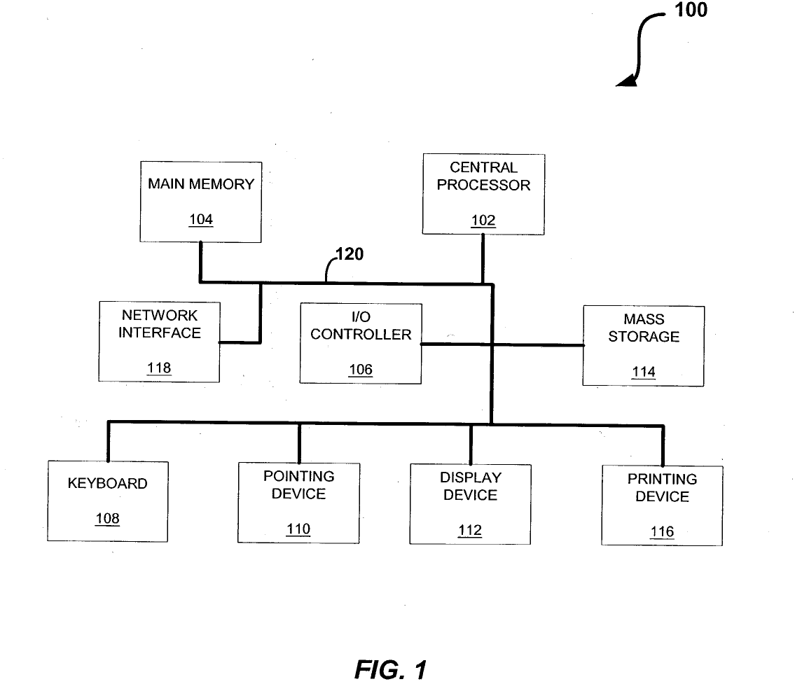

FIG. 1 illustrates an exemplary computer system 100 in which certain embodiments of the present invention may be implemented. The system 100 comprises a central processor 102, a main memory 104, an input/output (I/O) controller 106, a keyboard 108, a pointing device 110 (e.g., mouse, track ball, pen device, or the like), a display device 112, a mass storage 114 (e.g., a nonvolatile storage such as a hard disk, an optical drive, and the like), and a network interface 118. Additional input/output devices, such as a printing device 116, may be included in the system 100 as desired. As illustrated, the various components of the system 100 communicate through a system bus 120 or similar architecture.

In accordance with an embodiment of the present invention, the computer system 100 includes a Sun Microsystems computer utilizing a SPARC microprocessor available from several vendors (including Sun Microsystems, Inc., of Santa Clara, Calif.). Those with ordinary skill in the art understand, however, that any type of computer system may be utilized to embody the present invention, including those made by Hewlett Packard of Palo Alto, Calif., and IBM-compatible personal computers utilizing Intel microprocessor, which are available from several vendors (including IBM of Armonk, N.Y.). Also, instead of a single processor, two or more processors (whether on a single chip or on separate chips) can be utilized to provide speedup in operations. It is further envisioned that the processor 102 may be a complex instruction set computer (CISC) microprocessor, a reduced instruction set computing (RISC) microprocessor, a very long instruction word (VLIW) microprocessor, a processor implementing a combination of instruction sets, and the like.

The network interface 118 provides communication capability with other computer systems on a same local network, on a different network connected via modems and the like to the present network, or to other computers across the Internet. In various embodiments of the present invention, the network interface 118 can be implemented utilizing technologies including, but not limited to, Ethernet, Fast Ethernet, Gigabit Ethernet (such as that covered by the Institute of Electrical and Electronics Engineers (IEEE) 801.1 standard), wide-area network (WAN), leased line (such as T1, T3, optical carrier 3 (OC3), and the like), analog modem, digital subscriber line (DSL and its varieties such as high bit-rate DSL (HDSL), integrated services digital network DSL (IDSL), and the like), cellular, wireless networks (such as those implemented by utilizing the wireless application protocol (WAP)), time division multiplexing (TDM), universal serial bus (USB and its varieties such as USB II), asynchronous transfer mode (ATM), satellite, cable modem, and/or FireWire.

Moreover, the computer system 100 may utilize operating systems such as Solaris, Windows (and its varieties such as CE, NT, 2000, XP, ME, and the like), HP-UX, IBM-AIX, PALM, UNIX, Berkeley software distribution (BSD) UNIX, Linux, Apple UNIX (AUX), Macintosh operating system (Mac OS) (including Mac OS X), and the like. Also, it is envisioned that in certain embodiments of the present invention, the computer system 100 is a general purpose computer capable of running any number of applications such as those available from companies including Oracle, Siebel, Unisys, Microsoft, and the like.

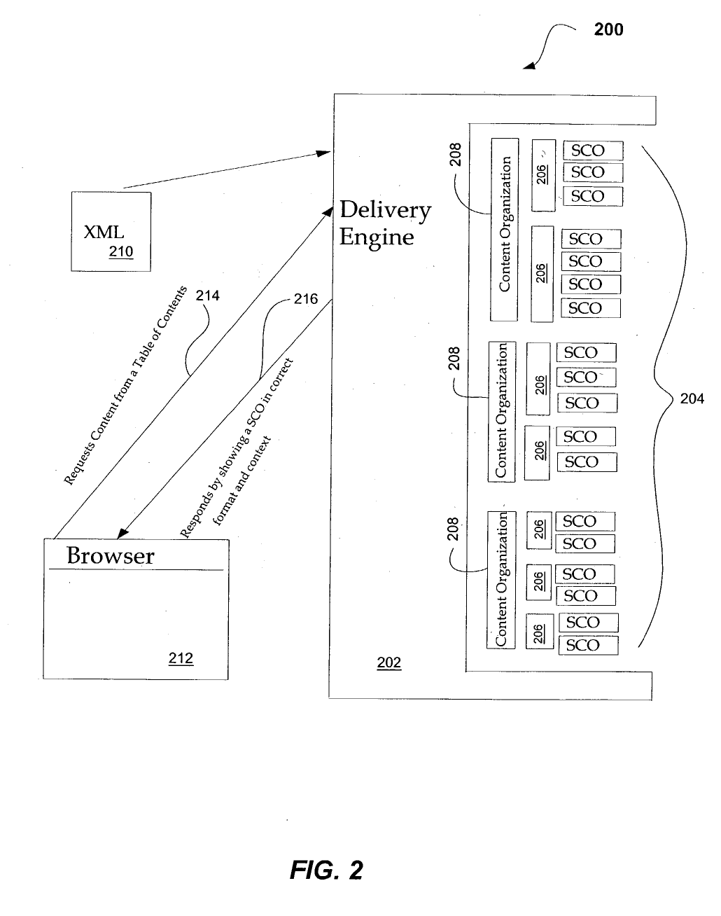

FIG. 2 illustrates an exemplary block diagram of a client-side system 200 in accordance with an embodiment of the present invention. In one embodiment of the present invention, the client-side system may be applied to SCORM-based courseware. The system 200 includes a delivery engine 202, which is in communication with one or more SCOs 204, modules 206, and content organization 208. It is envisioned that the courseware may be organized hierarchal by utilizing the SCOs 204, modules 206 and content organizations 208 as illustrated in FIG. 2.

In one embodiment of the present invention, the content organizations 208 may each represent a course. The delivery engine 202 may provide the functionality and look and feel for the way it is going to find and display the organized content to the user. In an embodiment of the present invention, the delivery engine utilizes information from an extensible markup language (XML) file 210 to deliver the SCO content in the correct format to a browser 212. In one embodiment of the present invention, the browser 212 may be selected from any available browsers such as the Internet Explorer available from Microsoft Corporation of Redmond, Wash., and the Netscape Navigator available from various sources including Sun Microsystems, Inc., of Santa Clara, Calif.

In one embodiment, the XML file 210 may be organized in accordance with the SCORM standard. For example the XML file 210 may be called a course structure format (CSF) file or a manifest file, which defines content organization in accordance with the SCORM standard (e.g., SCORM 1.1 and 1.2, respectively). Accordingly, the data from the XML file 210 may be utilized by the delivery engine 202 to generate an organized course (e.g., having a table of contents).

In another embodiment of the present invention, a user viewing a table of content through the browser 202 may request specific content associated with the table of content items through the delivery engine 202 (214). The delivery engine 202 in turn will respond to the use's browser 202 by showing a SCO in a correct format and context (216).

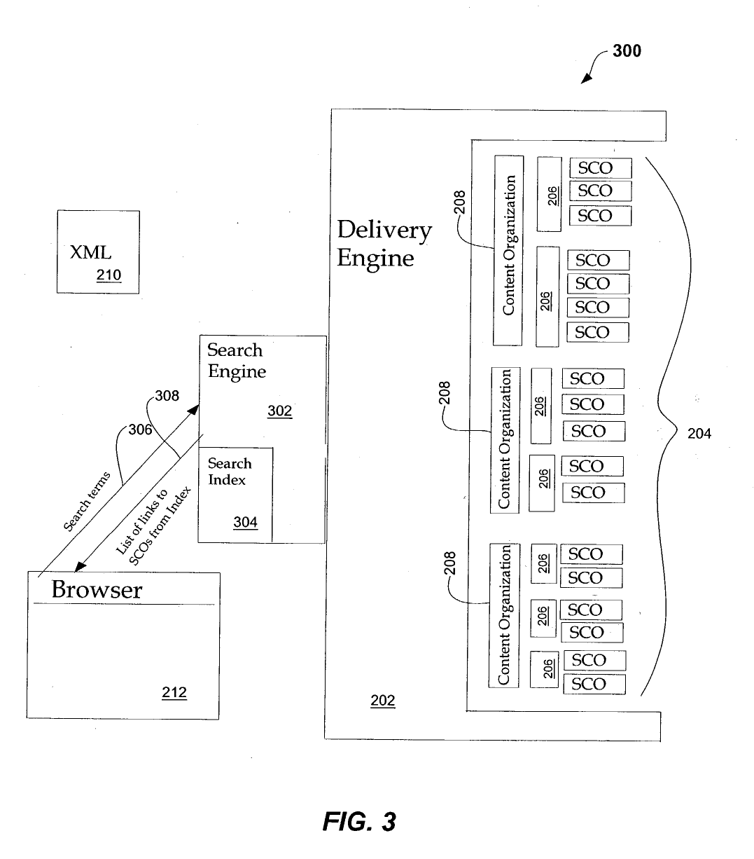

FIG. 3 illustrates an exemplary block diagram of a client-side system 300 with a search engine in accordance with an embodiment of the present invention. As illustrated, the client-side system 300 includes the delivery engine 202, the SCOs 204, the modules 206, the courses or content organizations 208, the XML file 210, and the browser 212. The client-side system 300 further includes a search engine 302, which communicates with the browser 212. In one embodiment of the present invention, the search engine 202 may further include a search index 304 which is envisioned to include data appropriate for performing searches of the courses 208 and the affiliated content (such as SCOs 204 and modules 206).

For example, if the search engine 302 is configured for searching text data, it is envisioned that all text data from all courses 208 (including the contents 204 and modules 206) would be included while excluding other extraneous information which may be data intensive such as media images, video, sound, hyper text markup language (HTML) tags, JavaScript functions, empty spaces, and the like. Similarly, for an HTML tag search, all other information may be excluded from the search index 304. In accordance with one embodiment of the present invention, it is envisioned that there could be multiple search indices 304 to perform different types of searches. It is envisioned that the provision of specialized search tools may enable a faster and more storage efficient solution for searching content. Of course, it is also envisioned that such search tools may be combined in a single graphical user interface (GUI).

In accordance with another embodiment of the present invention, a user may provide search terms through the browser 212 to the search engine 302 (306). The search engine 302 then may utilize search terms together with the search index 304 data and return a list of links to the matching SCOs (e.g., from the index 304) to the browser 212 (308). The matched SCOs may then be viewable by user upon selection. It is envisioned that the user may click on individual links to navigate to the appropriate content(s).

In one embodiment of the present invention, the list of the links is prioritized based on the highest number of matches in each individual SCO 204. In a further embodiment of the present invention, a list of links may be illustrated with the title of the matching SCO, module, and course. Accordingly, the SCOs may be shown with the next two higher levels of organizations.

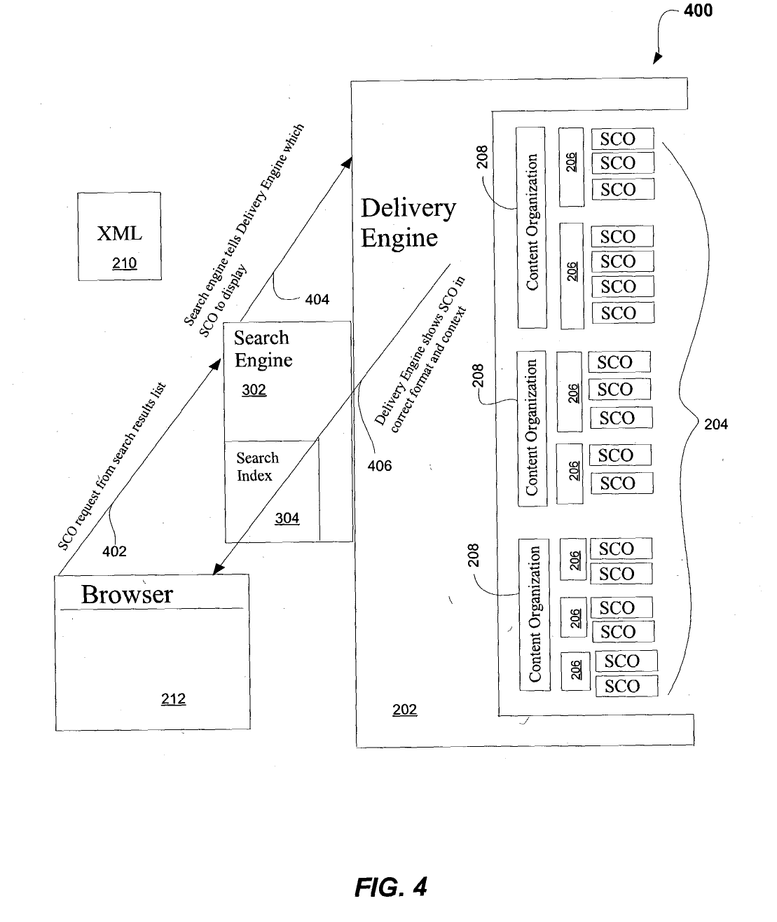

FIG. 4 illustrates an exemplary client-side search engine system 400 in accordance with an embodiment of the present invention. The search engine system 400 includes the XML file 210, the browser 212, the search engine 302, the search index 304, the delivery engine 202, the SCOs 204, the modules 206, and the content organization (courses) 208. In accordance with another embodiment of the present invention, when the user wants to view a selected SCO from a search result, a request from the search result list (e.g., through the browser 212) is sent to the search engine 302 (402). The search engine 302 then informs the delivery engine 202 which SCO to display (404). Once the delivery engine 202 receives the SCO information from the search engine 302, the delivery engine 202 shows the SCO in a correct format and context to the browser 212 (406).

In accordance with one embodiment of the present invention, a SCO launcher may utilize JavaScript to communicate to the delivery engine 202 that a particular SCO needs to be displayed. The SCO launcher further ensures that the appropriate tracking mechanisms are triggered for a new SCO by the delivery engine 202. The SCO launcher may be modified by the developer to communicate appropriately with different types of delivery engines.

In an embodiment of the present invention, a SCO in its entirety may be accessible in response to a selection by the user through browser 212. For example, once a user selects a found SCO for viewing, the user will be navigated to the first page or first occurrence of the search term in that SCO. Additionally, the number of matches of the search terms within each selected SCO may be displayed and/or the search terms may be highlighted within the displayed SCO. In accordance with another embodiment of the present invention, each SCO may be made as small as possible to facilitate usage of the content for reference purposes. Moreover, the smaller SCO may provide a faster access and/or searching capabilities.

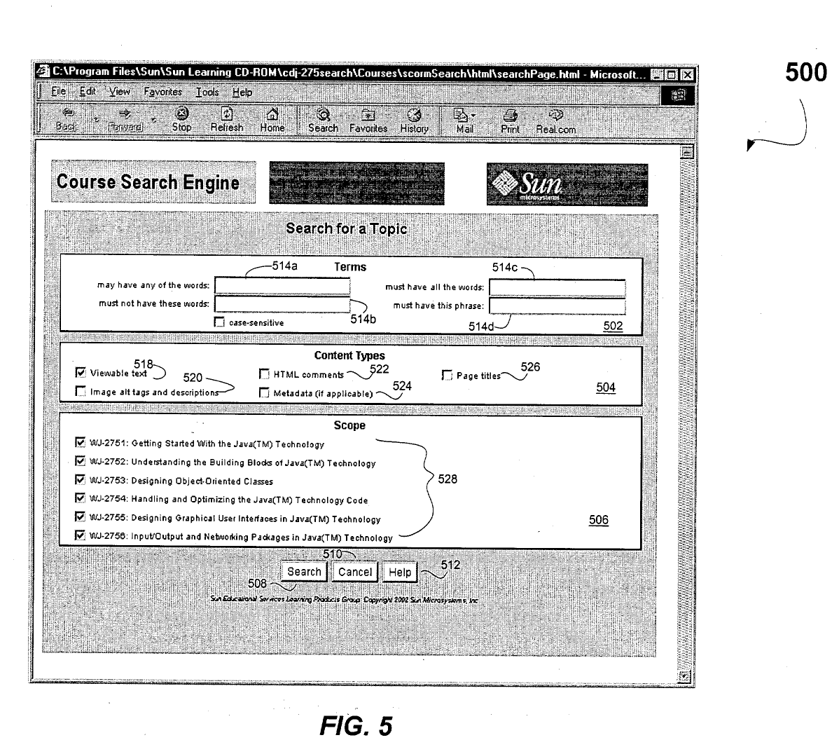

FIG. 5 illustrates an exemplary search parameter graphical user interface (GUI) 500 in accordance with an embodiment of the present invention. The GUI 500 displays search parameters to the user enabling the user to define the scope of the search. The GUI 500 includes a search terms area 502, a content types area 504, a search scope area 506, a search button 508 (e.g., to initiate a search utilizing the selected options and or terms provided in the areas 502-506), a cancel button 510 (e.g., to cancel the search and exit the GUI 500), and a help button 512 (e.g., to provide help information regarding the GUI 500).

As illustrated in FIG. 5, the search terms area 502 may include four fields 514a-d where search terms may be entered such as: 514a: for matching any words; 514b: for not matching all words; 514c: for matching all words; and 514d: for matching the given phrase. The search terms area 502 may further include a selection box for indicating whether the search should be case-sensitive. The content area 504 may include one or more selection boxes to indicate what type of content is to be searched such as viewable text 518, image alt tags and descriptions 520, HTML comments 522, Metadata 524, and/or page titles 526. The search scope area 506 may further include selection buttons 528 to indicate which courses or portions of the data should be searched. In one embodiment of the present invention, the top level of courseware organization defined in the XML files is listed in the search scope area 506. Accordingly, in addition to the user parameters provided by a typical search engine, the user also has an option to search items such as image tags, comments different types of pages, meta data, and the like. However, the indexes (such as the search index 304) should first contain the appropriate data types for such searches to take place.

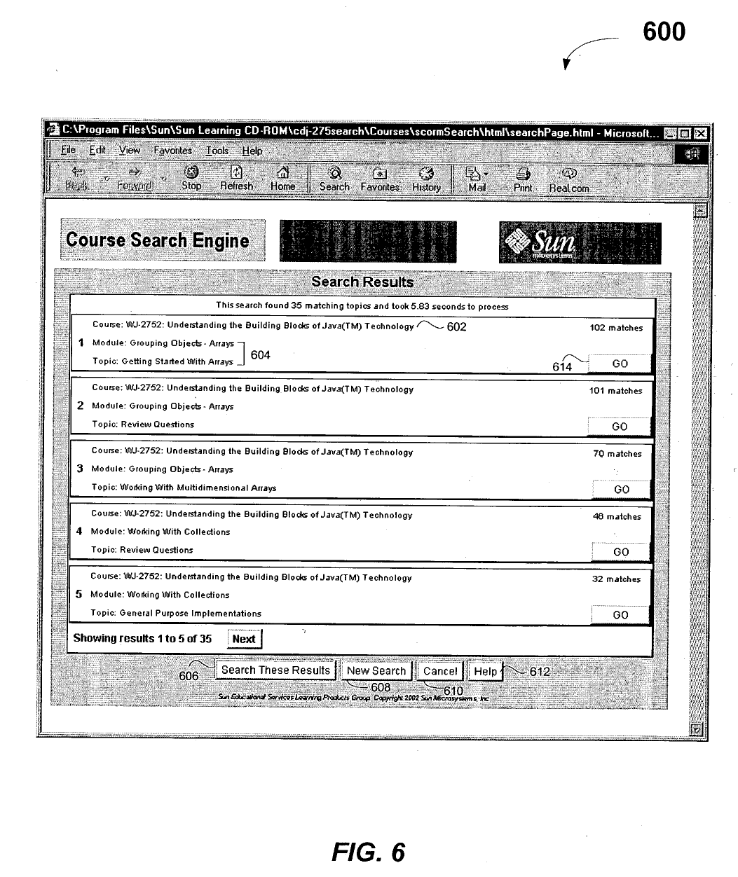

FIG. 6 illustrates an exemplary search result display 600 in accordance with an embodiment of the present invention. The display 600 illustrates the search results in order of most matches first. The SCO title is shown (602) as well as the titles of the next two higher levels of course organization in which the SCO appears (604). Furthermore, the display 600 provides the user with the option to perform another search, e.g., through selecting 606 to search the results and/or 608 to perform a new search such as discussed with reference to FIG. 5. The display 600 also includes a cancel button 610 (e.g., to exit the search result display 600) and a help button 612 to provide helpful information regarding the display 600. Furthermore, selecting a button 614 will allow the user to navigate to the selected course.

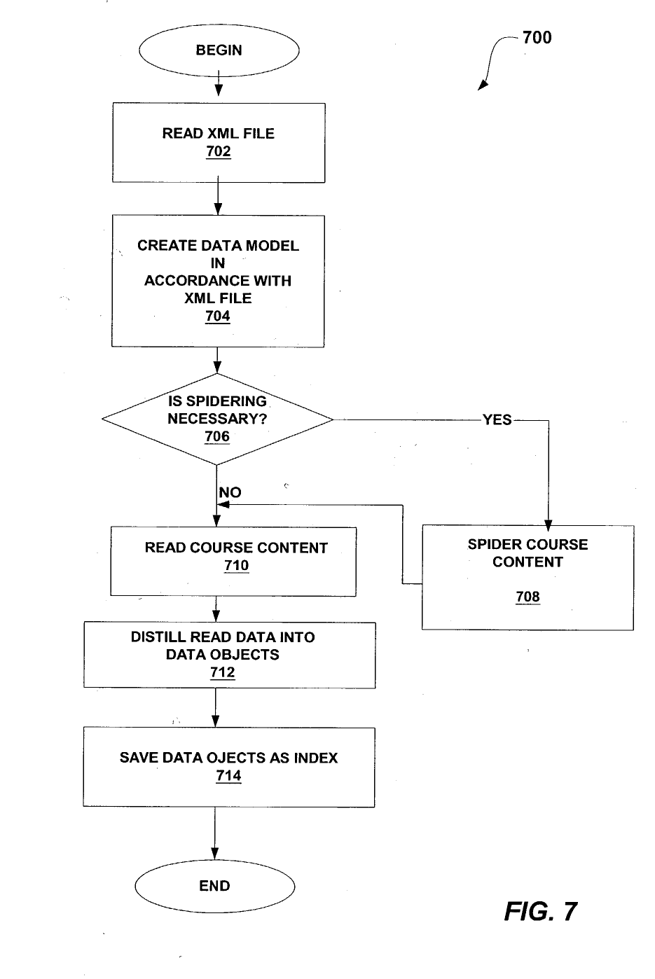

FIG. 7 illustrates an exemplary full diagram of an index creation method 700 in accordance with an embodiment of the present invention. In one embodiment of the present invention, the method 700 utilizes the data from the XML file 210 to build an index with the same structure of the course. In a further embodiment of the present invention, the search engine 302 may be utilized to perform the method 700. In accordance with another embodiment of the present invention, the course developer may run the index creator method prior to course delivery.

The method 700 starts in a stage 702, which reads content organization data from the XML file (such as the XML file 210). In a stage 704, the method 700 creates a data model in accordance with the data from the XML file. A stage 706 determines whether spidering is necessary. For example, with reference to the SCORM standard, spidering may not be required for SCORM 1.2 whereas it might be required for SCORM 1.1. Generally, spidering is the process of determining all linked pages associated with a content source such as a course. If it is determined by the stage 706 that spidering is required, the method 700 spiders the course content in a stage 708. Then, the method 700 continues at a stage 710, which reads course content data (e.g., the CSF file for SCORM 1.1 or the manifest file for SCORM 1.2).

A stage 712 distills the read data into data objects. The stage 714 then saves the data objects as an index for future use. After the stage 714, the method 700 terminates. The index created by the method 700 may be delivered with the courseware. In accordance with a different embodiment of the present invention, the Java classes that created the index are not delivered with the course.

In accordance with an embodiment of the present invention, a client-side search engine for SCORM courseware enables users of portable courseware such as those that are provided on CD-ROMs perform relatively complex searches of the course content and find topics which match the search terms. Advantages of such a client site search engine include limiting the smallest portion of a search to a SCO and also displaying information the way it is designed to be shown (e.g., in accordance with the SCORM standard).

In another embodiment of the present invention, a search engine tuned to specifically search for SCORM learning objects (e.g., SCOs) is disclosed. In accordance with a different embodiment of the present invention, such a search engine would be useful to content developers who need to find and select learning objects for use in the training they are producing. It is also desirable to intelligently sequence learning objects in a course during run time (i.e., when a student is interacting with the course content). The capability of dynamically selecting and displaying a learning object would allow for delivery of training that intelligently adapts to the individual student.

The foregoing description has been directed to specific embodiments. It will be apparent to those with ordinary skill in the art that modifications may be made to the described embodiments, with the attainment of all or some of the advantages. For example, the techniques of the present invention may be applied to courseware, reference material, and the like. Therefore, it is the object of the appended claims to cover all such variations and modifications as come within the spirit and scope of the invention.

What is claimed is:

1. A client-side search engine comprising:
a delivery engine;
content data accessible by the delivery engine;
a data storage to store organizational data corresponding to the content data;
a browser coupled to the delivery engine to communicate with the delivery engine; and
a search engine coupled between the browser and the delivery engine to perform a search in accordance with one or more search terms provided by the browser.

2. The client-side search engine of claim 1 wherein the search engine further includes a search index, the search index storing searchable data corresponding to the content data.

3. The client-side search engine of claim 2 wherein the search index includes data selected from a group comprising text data, HTML comment data, metadata, image tag data, and image description data.

4. The client-side search engine of claim 2 wherein after the search engine performs the search, the search engine returns a list of one or more links to matching content in accordance with the search index.

5. The client-side search engine of claim 4 wherein the matching content is one or more SCOs.

6. The client-side search engine of claim 5 wherein the search engine further returns a number of matches for each SCO.

7. The client-side search engine of claim 1 further including the delivery engine displaying a portion of the content data in at least one of a correct format and a correct context.

8. The client-side search engine of claim 7 wherein the portion of the content data is a SCO containing data found by the search engine.

9. The client-side search engine of claim 1 wherein the content data is stored in a hierarchical format.

10. The client-side search engine of claim 1 wherein the content data is stored in accordance with SCORM.

11. The client-side search engine of claim 1 wherein the data storage is an XML file.

12. The client-side search engine of claim 1 wherein Java is utilized to implement at least one item selected from a group comprising the delivery engine, the browser, and the search engine.

13. A method of creating an index for a client-side search engine, the method comprising:
reading organizational data corresponding to content data;
creating a data model corresponding to the organizational data;
reading the content data;
distilling the read content data into a plurality of data objects; and
saving the plurality of data objects as an index.

14. The method of claim 13 further including saving the plurality of data objects as a plurality of indices.

15. The method of claim 14 wherein each of the plurality of indices corresponds to a particular data type.

16. The method of claim 14 wherein the particular data type is selected from a group comprising text data, HTML comment data, metadata, image tag data, and image description data.

17. The method of claim 13 further including determining whether the organizational data necessitates spidering.

18. The method of claim 17 wherein if it is determined that spidering is required, spidering the content data after creating the data model.

19. An article of manufacture comprising:
a machine readable medium that provides instructions that, if executed by a machine, will cause the machine to perform operations including:
reading organizational data corresponding to content data;
creating a data model corresponding to the organizational data;
reading the content data;
distilling the read content data into a plurality of data objects; and
saving the plurality of data objects as an index.

20. The article of claim 19 wherein the operations further include saving the plurality of data objects as a plurality of indices.

21. The article of claim 19 wherein the operations further include determining whether the organizational data necessitates spidering.

22. A computer system comprising:
a central processing unit (CPU);
a storage device coupled to the CPU and to store:
a delivery engine;
content data accessible by the delivery engine;
organizational data corresponding to the content data;
a browser coupled to the delivery engine to communicate with the delivery engine; and
a search engine coupled between the browser and the delivery engine to perform a search in accordance with one or more search terms provided by the browser.

23. The computer system of claim 22 wherein the delivery engine displays a portion of the content data in at least one of a correct format and a correct context.

24. The computer system of claim 23 wherein the portion of the content data is a SCO containing data found by the search engine.

25. The computer system of claim 22 wherein the content data is stored in accordance with SCORM.

26. The computer system of claim 22 wherein the storage device is selected from a group comprising floppy diskette, hard disk, optical disk, compact disc-read only memory (CD-ROM), magneto-optical disk, read-only memory (ROM), random-access memory (RAM), erasable programmable ROM (EPROM), electrically EPROM (EEPROM), magnetic or optical card, and flash memory.

27. The computer system of claim 22 wherein the CPU is selected from a group comprising a complex instruction set computer (CISC) microprocessor, a reduced instruction set computing (RISC) microprocessor, a very long instruction word (VLIW) microprocessor, and a processor implementing a combination of instruction sets.
